(19) United States
(12) Patent Application Publication
(10) Pub. No.: US 2026/0073794 A1
(43) Pub. Date: Mar. 12, 2026

(54) SYSTEMS AND METHODS FOR PREVENTING UNSAFE DRIVING BEHAVIOR

(71) Applicant: Toyota Motor Engineering & Manufacturing North America, Inc., Plano, TX (US)

(72) Inventors: Seyhan Ucar, Mountain View, CA (US); Emrah Akin Sisbot, Menlo Park, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/829,764

(22) Filed: Sep. 10, 2024

(51) Int. Cl. G08G 1/16; G08G 1/01; G08G 1/0967

(52) U.S. Cl. CPC G08G 1/164; G08G 1/0133; G08G 1/0141; G08G 1/0145; G08G 1/096725; G08G 1/166

(57) ABSTRACT

Systems and methods for preventing unsafe driving behavior are disclosed herein. One embodiment of an unsafe driving behavior prevention system detects a traffic situation in which a potential triggering action by one or more connected-vehicle drivers is predicted to trigger an undesirable driving habit of another driver. The system also generates guidance for the one or more connected-vehicle drivers regarding control of their respective connected vehicles to prevent the one or more connected-vehicle drivers from carrying out the potential triggering action. The system also transmits the guidance to the one or more connected-vehicle drivers to prevent an unsafe traffic situation by preventing triggering of the undesirable driving habit.

### TECHNICAL FIELD

The subject matter described herein generally relates to vehicles and, more particularly, to systems and methods for preventing unsafe driving behavior by leveraging connected-vehicle technology.

### BACKGROUND

Unsafe driving—driving that abuses or jeopardizes the safety of others—is a major problem. For example, over half of all accidents involve at least one aggressive driver. A recent survey indicates that 87% of U.S. drivers have engaged in distracted driving. Rear-end collisions are the most frequently occurring type of collision in the U.S., and most of them occur due to distracted or reckless driving behavior of the driver in the following vehicle.

Technologies exist to detect the unsafe driving behavior of drivers in nearby approaching vehicles. Unfortunately, it might be too late to warn or guide an innocent driver regarding the potential danger because the other driver's unsafe driving may have already escalated into a road-rage incident. Technologies also exist to persuade or advise a driver not to engage in unsafe driving behaviors, but aggressive or reckless drivers often ignore, resent, or disable such solutions.

### SUMMARY

An example of a system for preventing unsafe driving behavior is presented herein. The system comprises a processor and a memory storing machine-readable instructions that, when executed by the processor, cause the processor to detect a traffic situation in which a potential triggering action by one or more connected-vehicle drivers is predicted to trigger an undesirable driving habit of another driver. The memory also stores machine-readable instructions that, when executed by the processor, cause the processor to generate guidance for the one or more connected-vehicle drivers regarding control of their respective connected vehicles to prevent the one or more connected-vehicle drivers from carrying out the potential triggering action. The memory also stores machine-readable instructions that, when executed by the processor, cause the processor to transmit the guidance to the one or more connected-vehicle drivers to prevent an unsafe traffic situation by preventing triggering of the undesirable driving habit.

Another embodiment is a non-transitory computer-readable medium for preventing unsafe driving behavior and storing instructions that when executed by a processor cause the processor to detect a traffic situation in which a potential triggering action by one or more connected-vehicle drivers is predicted to trigger an undesirable driving habit of another driver. The instructions also cause the processor to generate guidance for the one or more connected-vehicle drivers regarding control of their respective connected vehicles to prevent the one or more connected-vehicle drivers from carrying out the potential triggering action. The instructions also cause the processor to transmit the guidance to the one or more connected-vehicle drivers to prevent an unsafe traffic situation by preventing triggering of the undesirable driving habit.

In another embodiment, a method of preventing unsafe driving behavior is disclosed. The method comprises detecting a traffic situation in which a potential triggering action by one or more connected-vehicle drivers is predicted to trigger an undesirable driving habit of another driver. The method also includes generating guidance for the one or more connected-vehicle drivers regarding control of their respective connected vehicles to prevent the one or more connected-vehicle drivers from carrying out the potential triggering action. The method also includes transmitting the guidance to the one or more connected-vehicle drivers to prevent an unsafe traffic situation by preventing triggering of the undesirable driving habit.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a connected vehicle in accordance with various embodiments of the systems and methods disclosed herein.

FIG. 2 is a diagram of an unsafe driving behavior prevention system communicating with connected vehicles, in accordance with an illustrative embodiment of the invention.

FIGS. 3A and 3B illustrate a scenario in which an unsafe driving behavior prevention system prevents an unsafe traffic situation by preventing the triggering of a driver's undesirable driving habit, in accordance with an illustrative embodiment of the invention.

FIG. 4 is a diagram of a methodology of preventing unsafe driving behavior, in accordance with an illustrative embodiment of the invention.

FIG. 5 is a flowchart of actions associated with the methodology of preventing unsafe driving behavior diagrammed in FIG. 4, in accordance with an illustrative embodiment of the invention.

FIG. 6 is a block diagram of an unsafe driving behavior prevention system, in accordance with an illustrative embodiment of the invention.

FIG. 7 is a flowchart of a method of preventing unsafe driving behavior, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Various embodiments of systems and methods for preventing unsafe driving behavior described herein leverage connected-vehicle technology to prevent the actions taken by drivers that trigger the undesirable driving habits of other drivers. By preventing the triggering of such undesirable driving habits, the various embodiments prevent unsafe traffic situations that can result in damage to vehicles and the injury or death of vehicle occupants.

Though the root causes of unsafe driving behavior can vary depending on the individual driver and the driver's circumstances, the various embodiments described herein acknowledge and address two leading causes: (1) a mindset in which a driver feels invincible and/or exempt from the rules of the road and (2) peer influence (e.g., pressure from peers or social circles to engage in risky driving behaviors, such as speeding or showing off).

In some embodiments, an unsafe driving behavior prevention system hosted at a remote server detects a traffic situation in which a potential triggering action by one or more connected-vehicle drivers is predicted to trigger an undesirable driving habit of another driver (the “subject driver”). In response, the system generates guidance for the one or more connected-vehicle drivers regarding control of their respective connected vehicles to prevent the one or more connected-vehicle drivers from carrying out the potential triggering action. The system then transmits the guidance to the one or more connected-vehicle drivers to prevent an unsafe traffic situation by preventing triggering of the undesirable driving habit. In some embodiments, local systems in the connected vehicles learn drivers'undesirable driving habits and the actions by other drivers that trigger the undesirable driving habits beforehand, and that information is uploaded to the unsafe driving behavior prevention system at the remote server. In other embodiments, the subject driver drives a legacy vehicle (i.e., a vehicle without network connectivity), and the undesirable driving habits of the subject driver and the associated triggering actions are learned or inferred by one or more nearby connected vehicles that observe the driving behavior of the subject driver.

In other embodiments, an unsafe driving behavior prevention system having the functionality described in the preceding paragraph is implemented in a distributed-computing fashion among a plurality of connected vehicles that are networked together in a vehicular micro cloud. In these embodiments, the vehicles cooperate with one another to perform the functions described herein. In these embodiments, the plurality of connected vehicles are driven by a respective plurality of connected-vehicle drivers, the plurality of connected-vehicle drivers including the subject driver to whom the undesirable driving habit pertains in the applicable detected traffic situation. In a variation of these embodiments, however, the subject driver, as discussed above, drives a legacy vehicle, and the vehicles in the vehicular micro cloud forming the unsafe driving behavior prevention system learn or infer the undesirable driving habits of the subject driver and the associated triggering actions through observation of the driving behavior of the subject driver.

Herein, the term “driver,” in some embodiments, refers to a human driver who drives a vehicle manually. In other embodiments, the term “driver” refers to an automated driving system. The automated driving system controls the operation (steering, acceleration, deceleration, and/or braking) of a vehicle to at least some extent. In some embodiments, the automated driving system achieves a high level of autonomy (e.g., SAE Level 3, 4, or 5). In other embodiments, the level of autonomy is lower (e.g., SAE Level 1 or 2). In some embodiments, the automated driving system controls the vehicle in what may be termed a semi-autonomous manner (e.g., an Advanced Driver-Assistance System (ADAS), adaptive cruise control, lane-keep-assist feature, parking-assist feature, etc.).

Herein, an “unsafe traffic situation” is one in which a driver is driving in an unsafe manner with respect to at least one other vehicle on the road. Such an unsafe traffic situation can, in some instances, lead to a crash. An unsafe traffic situation is sometimes, but not always, associated with road rage on the part of the driver who is driving unsafely. Unsafe driving is often a manifestation of a human driver's undesirable driving habits. Herein, “undesirable driving habits” refer, without limitation, to habitual aggressive driving, such as tailgating or cutting into a lane in front of another vehicle; distracted driving, which leads to swerving and/or delayed reactions; and reckless driving, such as green-light running and changing lanes without signaling. Again, such undesirable driving habits may, in some scenarios, be coupled with road rage.

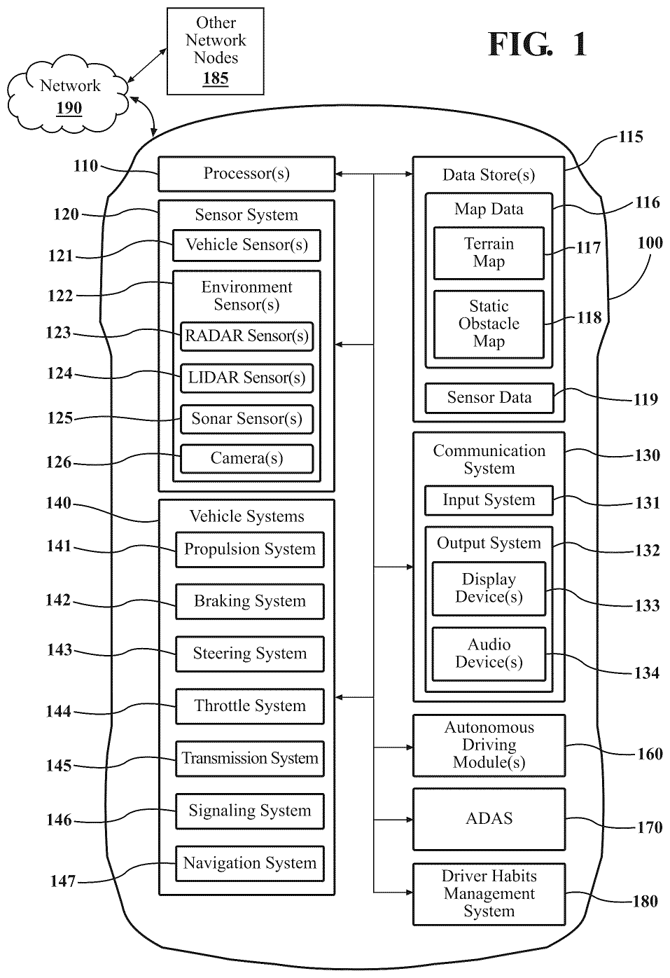

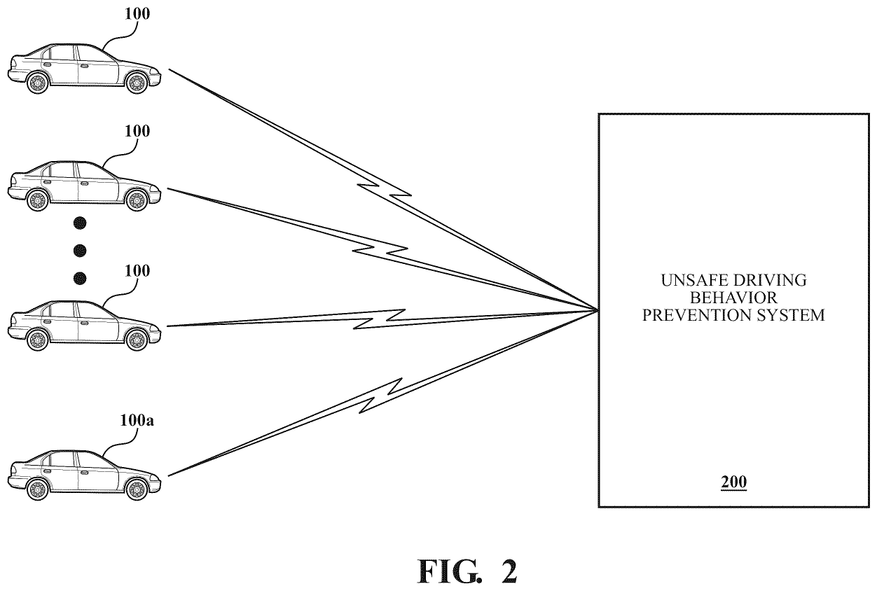

Referring to FIG. 1, it depicts a connected vehicle 100 that, in some embodiments, interacts with a remote-server-based unsafe driving behavior prevention system or, in other embodiments, forms part of a distributed-computing implementation of such a system. Various embodiments of an unsafe driving behavior prevention system are described in detail below beginning with the discussion of FIG. 2. The vehicle 100 is referred to as a “connected vehicle” because it is capable of communicating bidirectionally with other devices and systems external to the vehicle. As discussed above, in some embodiments a subject driver to whom an undesirable driving habit pertains in a detected potentially triggering traffic situation drives a legacy vehicle (i.e., a vehicle without network connectivity) instead of a connected vehicle 100.

In some embodiments, connected vehicle 100 is manually driven by a human driver. In other embodiments, connected vehicle 100 includes an automated driving system that enables connected vehicle 100 to operate in a semi-autonomous or autonomous driving mode at least some of the time. For example, in some embodiments, connected vehicle 100 can operate at a high or total level of autonomy (e.g., SAE Level 3, 4, or 5) under the control of autonomous driving module(s) 160. In other embodiments, connected vehicle 100 can operate in a semi-autonomous driving mode by virtue of features such as adaptive cruise control, automatic lane-keeping assistance, automatic lane-change assistance, and automatic parking assistance. In some embodiments, these and other semi-autonomous driving features are part of an Advanced Driver-Assistance System (ADAS) 170. In some embodiments, the ADAS 170 can intervene (e.g., temporarily take control of acceleration/deceleration and/or steering) to avoid a collision or other accident.

As indicated in FIG. 1, the connected vehicle 100 includes other elements. It will be understood that, in various implementations, it may not be necessary for the connected vehicle 100 to have all the elements shown in FIG. 1. The connected vehicle 100 can have any combination of the various elements shown in FIG. 1. Further, the connected vehicle 100 can have additional elements to those shown in FIG. 1. In some arrangements, the connected vehicle 100 may be implemented without one or more of the elements shown in FIG. 1. While the various elements are shown as being located within the connected vehicle 100 in FIG. 1, it will be understood that one or more of these elements can be located external to the connected vehicle 100. Further, the elements shown may be physically separated by large distances. Some of the possible elements of the connected vehicle 100 are shown in FIG. 1. However, a description of many of the elements in FIG. 1 will be provided after the discussion of FIGS. 2-7 for purposes of brevity of this description.

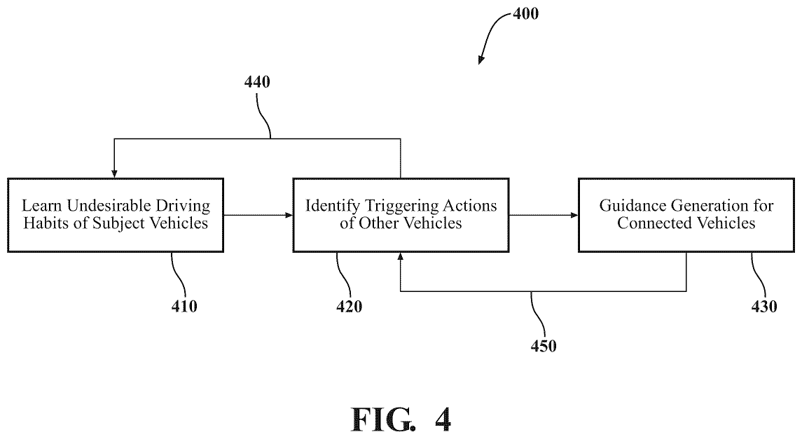

Sensor system 120 can include one or more vehicle sensors 121. Vehicle sensors 121 can include one or more positioning systems such as a dead-reckoning system or a global navigation satellite system (GNSS) such as a global positioning system (GPS). Vehicle sensors 121 can also include Controller-Area-Network (CAN) sensors that output, for example, speed and steering-angle data pertaining to connected vehicle 100. Sensor system 120 can also include one or more environment sensors 122. Environment sensors 122 generally include, without limitation, radar sensor(s) 123, Light Detection and Ranging (LIDAR) sensor(s) 124, sonar sensor(s) 125, and camera(s) 126. One or more of these various types of environment sensors 122 can be used to detect objects (e.g., external road agents such as other vehicles, bicyclists, motorcyclists, pedestrians, and animals) and, in other respects, understand the environment surrounding connected vehicle 100 and its associated traffic situations and conditions. This process is sometimes referred to as “traffic-situation understanding” or “scene understanding. ” As indicated in FIG. 1, connected vehicle 100 includes a driver habits management system 180. Driver habits management system 180 supports the ability of connected vehicle 100 to interact with or form part of an unsafe driving behavior prevention system by performing two prerequisite processes: (1) learning the undesirable driving habits of a specific driver who operates a particular connected vehicle 100 and (2) identifying, for each of the driver's undesirable driving habits, the action or actions of the drivers of other vehicles that trigger (lead to) that undesirable driving habit. These two prerequisite processes are discussed in greater detail below in connection with FIG. 4. In embodiments in which a subject driver drives a legacy vehicle, the subject driver's undesirable driving habits and the associated triggering actions can be learned or inferred by one or more nearby connected vehicles 100 that communicate with or form part of an unsafe driving behavior prevention system, as described in greater detail below.

As shown in FIG. 1, connected vehicle 100 can communicate with other network nodes 185 (e.g., other connected vehicles 100, cloud servers, edge servers, roadside units (RSUs), infrastructure such as traffic signals, etc.) via a network 190. In some embodiments, network 190 includes the Internet. In communicating with the other network nodes 185, connected vehicle 100 can employ technologies such as, without limitation, cellular data (e.g., LTE, 5G, 6G), Cellular Vehicle-to-Everything (C-V2X), IEEE 802.11 (Wi-Fi), millimeter wave, Dedicated Short-Range Communications (DSRC), Bluetooth® Low Energy (BLE), and visible-light communication.

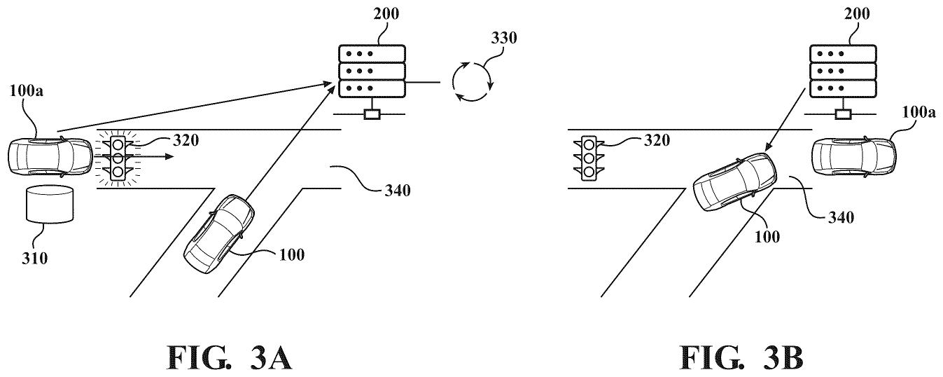

FIG. 2 is a diagram of an unsafe driving behavior prevention system 200 communicating with a plurality of connected vehicles 100, in accordance with an illustrative embodiment of the invention. In the embodiment of FIG. 2, unsafe driving behavior prevention system 200 is implemented in a server computing system that is remote from the plurality of connected vehicle 100 with which it communicates. Unsafe driving behavior prevention system 200 (hereinafter sometimes referred to simply as “system 200”) is in communication with not only the connected vehicles 100 but also with traffic information systems, map-data providers, and/or infrastructure systems (e.g., RSUs, edge servers, and/or traffic signals). Those other information sources are not shown in FIG. 2 for simplicity. Data regarding a particular connected-vehicle driver's undesirable driving habits and the actions of other drivers that tend to trigger those undesirable driving habits (triggering actions) has also been uploaded previously to the system 200 from the driver habits management systems 180 of the respective connected vehicles 100. Moreover, by communicating with the connected vehicles 100, system 200 is able to track the location, speed, and trajectory of each connected vehicle 100 in real time. All this information in combination enables system 200 to detect a traffic situation in which a potential triggering action by one or more connected-vehicle drivers is predicted to trigger an undesirable driving habit of another driver. Such a traffic situation is sometimes referred to herein as a “potentially triggering traffic situation. ” Examples of potentially triggering traffic situations are discussed in detail below (e.g., see the discussion of the merge example in FIGS. 3A and 3B).

In the embodiment of FIG. 2, the connected vehicles 100 are fungible (interchangeable), but one of the plurality of connected vehicles 100 has been labeled as connected vehicle “100a” to distinguish it from the other connected vehicles 100. For purposes of this description, connected vehicle 100a is a connected vehicle 100 whose human driver is the subject of a potentially triggering traffic situation detected by unsafe driving behavior prevention system 200. That is, the human driver of connected vehicle 100a is the driver whose undesirable driving habit is predicted to be triggered by a potential triggering action by one or more other connected-vehicle drivers, if that potential triggering action were to occur (the term “potential” is used, in this context, to convey that the trigger action has not yet occurred but is predicted to occur, if no effort is made to prevent it from happening). For this reason, connected vehicle 100a is hereinafter referred to as “subject connected vehicle 100a,” and the driver of subject connected vehicle 100a is hereinafter referred to as the “subject driver. ” The drivers, whether human or automated, of the other connected vehicles 100 besides subject connected vehicle 100a involved in a detected potentially triggering traffic situation are, for purposes of this description, sometimes referred to as “innocent” drivers. One such driver is also sometimes referred to herein as the driver of an “ego connected vehicle 100.” The innocent or ego-vehicle drivers are those who could potentially be put at risk by the triggering of the undesirable driving habit of the subject driver. As discussed above, in other embodiments, the vehicle driven by the subject driver is a legacy vehicle rather than a connected vehicle.

Once unsafe driving behavior prevention system 200 has detected a potentially triggering traffic situation, the system 200 generates guidance for the one or more innocent drivers of connected vehicles 100 involved in the potentially triggering traffic situation. The guidance concerns how a recipient innocent driver should control the connected vehicle 100 that that driver is driving. More specifically, the guidance instructs the recipient innocent driver to control that driver's connected vehicle 100 in a manner that prevents the potential triggering action from being carried out. This might involve the innocent driver taking a particular action, in some situations, or it might involve the innocent driver refraining from taking a particular action, in other situations. In generating guidance for a particular innocent driver, the system 200, in some embodiments, considers whether the driver has been receptive to similar guidance in the past and what kind of guidance tends to be most effective for that particular driver.

The system 200 then transmits the guidance to the one or more innocent drivers involved in the potentially triggering traffic situation. The guidance prevents an unsafe traffic situation by preventing the triggering of the subject driver's undesirable driving habit in the first place. Examples of potentially triggering traffic situations and the kinds of guidance that unsafe driving behavior prevention system 200 can provide are discussed further below. In some embodiments, the subject driver drives a legacy vehicle, but the system 200 can still transmit guidance to one or more connected vehicles 100 to preventing triggering an undesirable driving habit of the subject driver that has been inferred through observation of the subject driver's driving behavior by the one or more connected vehicles 100.

As discussed above, in some embodiments, unsafe driving behavior prevention system 200 is implemented in a distributed-computing fashion among a plurality of connected vehicles 100 that are networked together in a vehicular micro cloud. In these embodiments, the vehicles cooperate with one another to perform the functions described herein for the system 200. In some embodiments, a legacy vehicle driven by a subject driver is not part of the vehicular micro cloud or the unsafe driving behavior prevention system, but connected vehicles that are part of the system can still receive guidance to avoid triggering an undesirable driving habit of the subject driver inferred through observation of the subject driver's driving behavior.

FIGS. 3A and 3B illustrate a scenario in which an unsafe driving behavior prevention system 200 prevents an unsafe traffic situation by preventing the triggering of a subject driver's undesirable driving habit, in accordance with an illustrative embodiment of the invention. FIG. 3A depicts a situation in which the subject driver of subject connected vehicle 100a intends to proceed through a merge intersection 340 controlled by a traffic signal 320 when the traffic signal 320 turns green. At about the same time, the driver of another connected vehicle 100 intends to merge. In this example, system 200 is aware, from stored driver habits and triggering actions data 310, that the subject driver has an undesirable driving habit of becoming aggressive and tailgating a leading vehicle, if the other connected vehicle 100 were to merge ahead of subject connected vehicle 100a, forcing the subject driver to decelerate. In this example, the undesirable driving habit is tailgating (possibly accompanied by road rage), and the potential triggering action is the driver of the other connected vehicle 100 merging in front of the subject connected vehicle 100a, forcing the subject connected vehicle 100a to decelerate. The triggering action is a “potential triggering action” at this stage because it has not yet occurred (i.e., the driver of the other connected vehicle 100 has not yet decided to merge ahead of the subject driver).

In the example of FIG. 3A, system 200 detects the potentially triggering traffic situation and generates guidance for the driver of connected vehicle 100 (the innocent driver) to merge behind the subject connected vehicle 100a. In other words, the guidance instructs the driver of connected vehicle 100 to yield to the subject driver at the merge intersection 340, permitting the subject driver to proceed first through the merge intersection 340. The system 200 transmits the guidance to the driver of connected vehicle 100. The driver of connected vehicle 100 follows the received guidance to merge behind the subject connected vehicle 100a at the merge intersection 340, as depicted in FIG. 3B.

The example of FIGS. 3A and 3B illustrates how an unsafe driving situation (a driver tailgating another vehicle) can be prevented by preventing the triggering of the undesirable driving habit (tailgating) of the subject driver.

As explained further below, in some embodiments, a scenario such as that in FIGS. 3A and 3B can be addressed (i.e., a triggering action can be prevented) in a similar manner, even if the subject driver is driving a subject legacy vehicle instead of a subject connected vehicle 100a.

In other potentially triggering traffic situations, system 200 can transmit other kinds of guidance to the driver of a connected vehicle 100. Examples of such guidance include, without limitation, a speed advisory, a lane-keeping instruction (to remain in the current lane), and a lane-change instruction. For example, system 200 can transmit guidance to multiple connected vehicles 100 instructing the drivers of those vehicles to remain in their current somewhat congested lane to prevent a nearby subject driver's undesirable driving habit of tailgating from being triggered by the connected vehicles 100 in the congested lane switching lanes in front of the subject driver's vehicle, forcing the subject driver's vehicle to decelerate. This example illustrates that, in some potentially triggering traffic situations, system 200 can transmit guidance to a plurality of connected vehicles 100 to prevent a potential triggering action.

FIG. 4 is a diagram of a methodology 400 of preventing unsafe driving behavior, in accordance with an illustrative embodiment of the invention. As shown in FIG. 4, methodology 400 includes (1) learning undesirable driving habits of subject vehicles 410, (2) identifying triggering actions of other vehicles 420, and (3) generating guidance for connected vehicles 430. Methodology 400 also includes driver-habits feedback 440 and guidance success feedback 450, both of which enable system 200 to be updated as needed to reflect up-to-date information regarding the undesirable driving habits and associated triggering actions of subject drivers. Each aspect of methodology 400 is discussed in greater detail below.

Regarding learning undesirable driving habits of subject vehicles 410, in some embodiments, the driver habits management system 180 in a connected vehicle 100 learns the undesirable driving habits of a driver of that vehicle through automated observation of the driving of that driver over a period of time. In some embodiments, this is accomplished through use of a machine-learning-based architecture that is part of driver habits management system 180. The observation and learning period can be brief (e.g., a single drive), or it can be longer (e.g., days, weeks, or months), depending on the embodiment.

Learning a subject driver's undesirable driving habits can include comparing, in real time, the driver's performance in controlling vehicle 100 with a reference or standard that represents “expected” or “normal” driving behavior (steering, braking, accelerating, use of turn signals, etc.), under the circumstances, and documenting or storing a record of the detected undesirable driving habits for future use. The reference for comparison can be the product of a machine-learning-based process, or the reference can be rules-based, depending on the implementation.

In one embodiment a driver habits learning architecture in driver habits management system 180 gathers information from vehicle sensors 121, cloud or edge servers, and other connected vehicles 100 for preprocessing and enhancement. In detecting distracted or inattentive driving, driver habits management system 180 can employ techniques such as tracking and analyzing the driver's gaze direction from sensor data (e.g., camera images). This information is fed to a situation understanding module. The situation understanding module includes object detection and the understanding of traffic situations (e.g., that the connected vehicle 100 should stop at a red light at an intersection connected vehicle 100 is approaching). A feature extraction module feeds a classification module, a clustering module, and a regression (prediction) module. Classification is an aspect of learning a driver's particular undesirable driving habits—e.g., classifying the driver's behavior as “aggressive,” “distracted,” “daydreaming,” “tailgating,” etc. Clustering identifies situational features that are common across various categories of undesirable driving habits, such as weather conditions, time of day, day of week, traffic density, etc. The outputs of the classification module, clustering module, and regression module are fed to a feedback/adaptation module. The machine-learning aspects of such a driver habits learning architecture can be implemented in various ways, depending on the embodiment. For example, in some embodiments, the regression module employs time-series analysis, in which the data is statistically analyzed to identify repeating movement patterns. The results of the undesirable-driving-habits learning process can be saved in a driver habits database in the connected vehicle 100 and updated as needed.

In some embodiments, a subject driver is driving a subject legacy vehicle rather than a subject connected vehicle 100a, or a learned driver habits database is not available for a subject driver driving a subject connected vehicle 100a. In these cases, one or more other connected vehicles 100 can predict a subject driver's undesirable driving habit through present analysis in real time of the subject driver's driving behavior through a machine-perception-based system in the one or more other connected vehicles 100. For example, a group of connected vehicles 100 networked in a vehicular micro cloud near a subject connected vehicle 100a that is stopped for a red traffic signal might detect, through their perception systems, that the subject connected vehicle 100a is repeatedly inching forward while the traffic signal remains red. From this observation, the remote server or the networked connected vehicles 100, in a distributed-computing embodiment, might infer that the subject driver (the driver of a legacy vehicle or a subject connected vehicle 100a without a driver habits database) has an undesirable driving habit of accelerating rapidly when a red traffic light turns green. Based on that information, the system 200 can generate guidance for one or more connected vehicles 100 that could be negatively impacted by the undesirable driving habit. Returning to the example of FIGS. 3A and 3B, the driver of the connected vehicle 100 approaching the merge intersection 340 could receive guidance, based on the present observation and analysis just mentioned, to allow the subject driver (the driver of subject connected vehicle 100a, which is repeatedly inching forward) to merge ahead of connected vehicle 100. This would prevent an unsafe traffic situation in which the subject driver tailgates the connected vehicle 100, possibly coupled with road rage.

Regarding identifying triggering actions of other vehicles 420, driver habits management system 180 or another system in connected vehicle 100 learns, through automated observation and analysis, the triggering action(s) by other connected-vehicle drivers that trigger an undesirable driving habit of a subject driver. That is, driver habits management system 180 or the other system just mentioned learns associations or correlations between triggering actions of other vehicles and the undesirable driving habits of a subject driver. For example, in the scenario discussed above in connection with FIGS. 3A and 3B, the driver habits management system 180 in subject connected vehicle 100a learns through automated observation that when the subject driver is forced to decelerate by another vehicle that merges ahead of the subject connected vehicle 100a, the subject driver begins driving aggressively in response (e.g., by tailgating the leading vehicle). In some embodiments, a machine-learning-based architecture can be used to associate or correlate the triggering action(s) with a particular undesirable driving habit of a subject driver. The machine-learning-based architecture, which can also be part of driver habits management system 180, can employ techniques such as, without limitation, time-series analysis, retrospective analysis, and/or event clustering. For example, the machine-learning-based architecture can go back and forth in the time domain to identify actions by other vehicles as triggering actions that lead to a subject driver engaging in an undesirable driving habit.

Regarding generating guidance for connected vehicles 430, this can be performed at a remote server, or it can be performed in a distributed-computing fashion by a plurality of connected vehicles 100 networked together in a vehicular micro cloud, as discussed above. As also discussed above, examples of guidance include, without limitation, a speed advisory, a lane-keeping instruction, a lane-change instruction, and an instruction to permit a subject connected vehicle 100a or a subject legacy vehicle to proceed, at a merge (e.g., merge intersection 340 in FIGS. 3A and 3B), ahead of an ego connected vehicle 100. As also mentioned above, in some potentially triggering traffic situations, system 200 can transmit guidance to a plurality of connected vehicles 100 to prevent a potential triggering action.

If system 200 is aware that a particular connected-vehicle driver tends not to follow a certain kind of guidance, system 200 can, in some situations, take compensating actions. For example, in the merge scenario of FIGS. 3A and 3B, if the system 200 knows, from prior observation, that the driver of connected vehicle 100 (also a somewhat aggressive driver) is unlikely follow the guidance of permitting the subject connected vehicle 100a or subject legacy vehicle to merge ahead of the connected vehicle 100, system 200 can communicate with traffic signal 320 to lengthen the red-light cycle slightly to permit connected vehicle 100 to pass through and drive beyond the merge intersection 340 before the traffic signal 320 turns green for the subject connected vehicle 100a or subject legacy vehicle to avoid triggering aggressive driving behavior (tailgating) by the subject driver. In other scenarios, a potential conflict between two aggressive drivers can be avoided by the system 200 transmitting guidance to one of the connected-vehicle drivers to change lanes before reaching an intersection to avoid a merge bottleneck at a merge intersection 340 that might otherwise occur.

In some embodiments in which the driver of a connected vehicle 100 is an automated driving system (see definition of “driver” above), the automated driving system carries out guidance received from system 200 unconditionally.

Regarding driver-habits feedback 440, this aspect of methodology 400 involves updating and improving the mapping/relationship between a subject driver's undesirable driving habits and the associated triggering actions over time as system 200 learns more about the subject driver's undesirable driving habits and the underlying actions that trigger the undesirable driving habits. This aspect also accounts for changes, over time, in how a particular subject driver drives. One factor that can account for changes in the associations between a subject driver's undesirable driving habits and the triggering actions of other vehicles is the subject driver driving a different vehicle (e.g., an RV instead of an SUV). These differences in driving behavior for different vehicles can be accounted for via the indicated feedback loop (440).

Regarding guidance success feedback 450, this aspect of methodology 400 involves feeding back the success or failure of an intervention (e.g., guidance asking the driver of connected vehicle 100 to allow subject connected vehicle 100a to merge ahead of connected vehicle 100 in the example of FIGS. 3A and 3B) to improve the way the system operates over time. For example, if a connected-vehicle driver does not follow the guidance, the system might not output that same guidance in a similar situation in the future because it was unsuccessful in the past. As discussed above, the system 200 can take mitigating or compensating actions in cases where the system 200 knows a particular connected-vehicle driver is unlikely to follow guidance received from the system 200 or a potential conflict exists between two aggressive drivers.

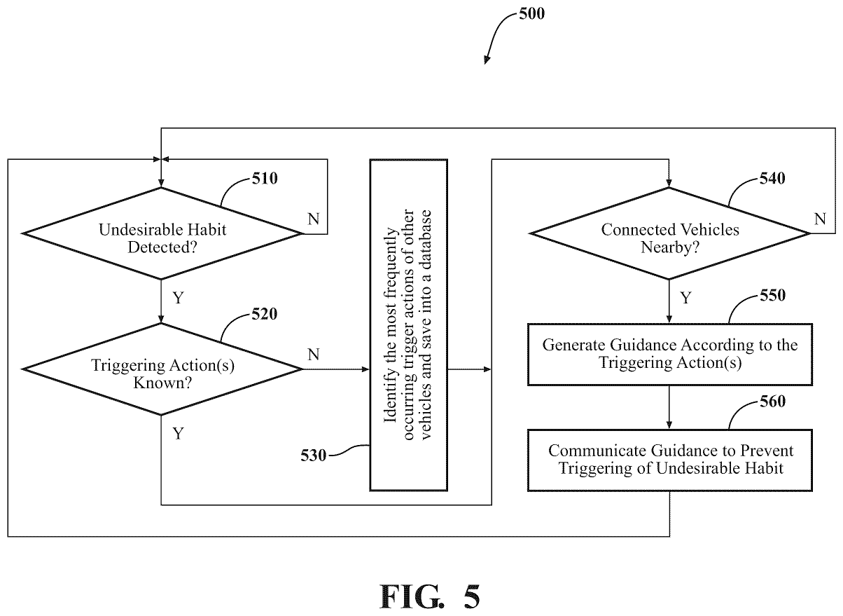

FIG. 5 is a flowchart of actions associated with the methodology 400 of preventing unsafe driving behavior diagrammed in FIG. 4, in accordance with an illustrative embodiment of the invention. At block 510, unsafe driving behavior prevention system 200 determines whether an undesirable driving habit of a subject driver has been detected. If so, at block 520, system 200 determines whether one or more triggering actions have been identified for the undesirable driving habit and the subject driver at issue. If not, at block 530, system 200, through the learning process (420) described above in connection with FIG. 4, identifies the most frequently occurring trigger actions of other vehicles for the undesirable driving habit at issue and saves that information in a collection of data (e.g., a database) concerning undesirable driving habits and their associated triggering actions.

At block 520, if one or more triggering actions are known for the undesirable driving habit at issue, system 200 proceeds, at block 540, to determine whether there are other connected vehicles 100 nearby (i.e., near the subject connected vehicle 100a or legacy vehicle driven by the subject driver). If so, system 200, at block 550, generates guidance for one or more affected (innocent) connected vehicles 100 in accordance with the triggering action(s) found at block 520. At block 560, system 200 communicates the guidance to the one or more affected connected vehicles 100 to prevent triggering of the undesirable driving habit. As discussed above, this, in turn, prevents the occurrence of an unsafe traffic situation.

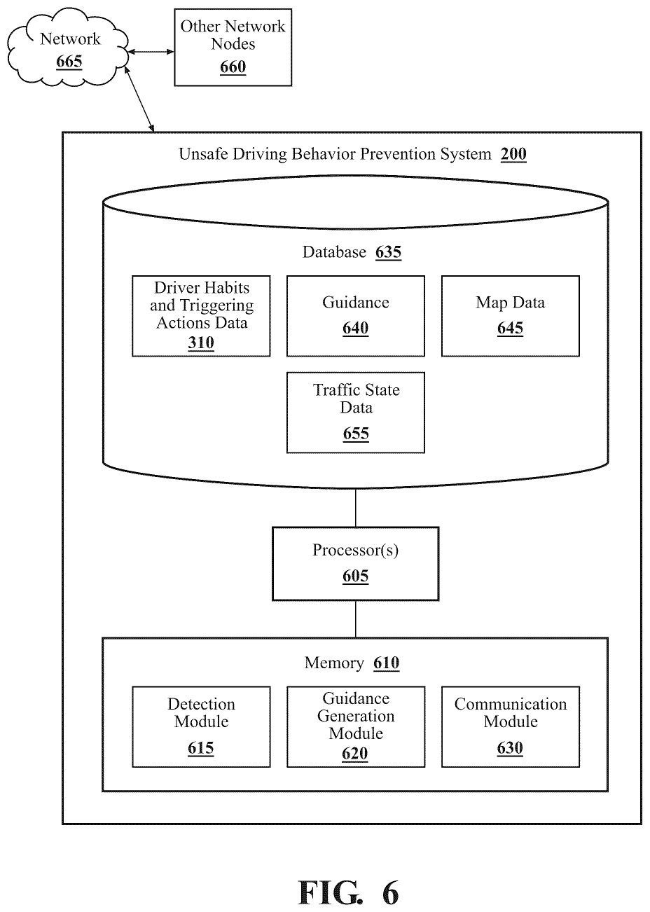

FIG. 6 is a block diagram of an unsafe driving behavior prevention system 200, in accordance with an illustrative embodiment of the invention. In FIG. 6, system 200 includes one or more processors 605 to which a memory 610 is communicably coupled. Memory 610 stores a detection module 615, a guidance generation module 620, and a communication module 630. The memory 610 is a random-access memory (RAM), read-only memory (ROM), a hard-disk drive, a flash memory, or other suitable non-transitory memory for storing the modules 615, 620, and 630. The modules 615, 620, and 630 are, for example, machine-readable instructions that, when executed by the one or more processors 605, cause the one or more processors 605 to perform the various functions disclosed herein. As discussed above, in some embodiments, unsafe driving behavior prevention system 200 is implemented in a server that is remote from the connected vehicles 100 with which it communicates. In other embodiments, system 200 is implemented in a distributed-computing fashion among a plurality of connected vehicles 100 that are networked together in a vehicular micro cloud. In these embodiments, the vehicles cooperate with one another to perform the functions described herein for the system 200 and share the computational load.

As also shown in FIG. 6, system 200 can store various kinds of data in a database 635. For example, system 200 can store, in database 635, driver habits and triggering actions data 310, guidance 640, map data 645, and traffic state data 655. Driver habits and triggering actions data 310 is the data produced by the processes discussed above in connection with the driver habits management system 180 in each connected vehicle 100 and the methodology 400, specifically learning undesirable driving habits of subject vehicles 410 and identifying triggering actions of other vehicles 420. Traffic state data 655 includes data from traffic information servers; data from weather servers; location, speed, and trajectory data received from individual connected vehicles 100; and/or data received from infrastructure devices, including traffic signals.

As also shown in FIG. 6, system 200 can communicate with other network nodes 660 (e.g., connected vehicles 100, servers, infrastructure devices, etc.) via a network 665. In some embodiments, network 665 includes the Internet. In communicating with the other network nodes 660, system 200 can employ technologies such as cellular data (e.g., LTE, 5G, 6G), Cellular Vehicle-to-Everything (C-V2X), IEEE 802.11 (Wi-Fi), millimeter wave, Dedicated Short-Range Communications (DSRC), Bluetooth® Low Energy (BLE), and visible-light communication.

Detection module 615 generally includes instructions that, when executed by the one or more processors 605, cause the one or more processors 605 to detect a traffic situation in which a potential triggering action by one or more connected-vehicle drivers is predicted to trigger an undesirable driving habit of another driver. As discussed above in connection with FIG. 2, system 200 is in communication with the connected vehicles 100 and also with traffic information systems, map-data providers, and infrastructure systems (e.g., RSUs, edge servers, and/or traffic signals). Data regarding a particular connected-vehicle driver's undesirable driving habits and the actions of other drivers that tend to trigger those undesirable driving habits (triggering actions) has also been uploaded to the system 200 beforehand from the driver habits management systems 180 of the respective connected vehicles 100. By communicating with the connected vehicles 100, system 200 can track the location, speed, and trajectory of each connected vehicle 100 in real time. Information from these various sources in combination enables system 200 to detect a traffic situation in which a potential triggering action by one or more connected-vehicle drivers is predicted to trigger an undesirable driving habit of another driver. As discussed above, such a traffic situation is herein sometimes referred to as a “potentially triggering traffic situation. ” One example of a potentially triggering traffic situation and how system 200 might handle it is discussed above in connection with FIGS. 3A and 3B.

Guidance generation module 620 generally includes instructions that, when executed by the one or more processors 605, cause the one or more processors 605 to generate guidance 640 for the one or more connected-vehicle drivers regarding control of their respective connected vehicles 100 to prevent the one or more connected-vehicle drivers from carrying out the potential triggering action. As discussed above, examples of guidance include, without limitation, a speed advisory, a lane-change instruction, and an instruction to permit a subject connected vehicle 100a or a subject legacy vehicle to proceed, at a merge (e.g., merge intersection 340 in FIGS. 3A and 3B), ahead of an ego connected vehicle 100. As also mentioned above, in some potentially triggering traffic situations, system 200 can transmit guidance to a plurality of connected vehicles 100 to prevent a potential triggering action. As also discussed above, system 200 can take mitigating or compensating actions in situations where a connected-vehicle driver is unlikely to carry out the guidance received from system 200 or in which two or more aggressive drivers are involved in a potentially triggering traffic situation.

Communication module 630 generally includes instructions that, when executed by the one or more processors 605, cause the one or more processors 605 to transmit the guidance 640 to the one or more connected-vehicle drivers to prevent an unsafe traffic situation by preventing triggering of the undesirable driving habit of the subject driver.

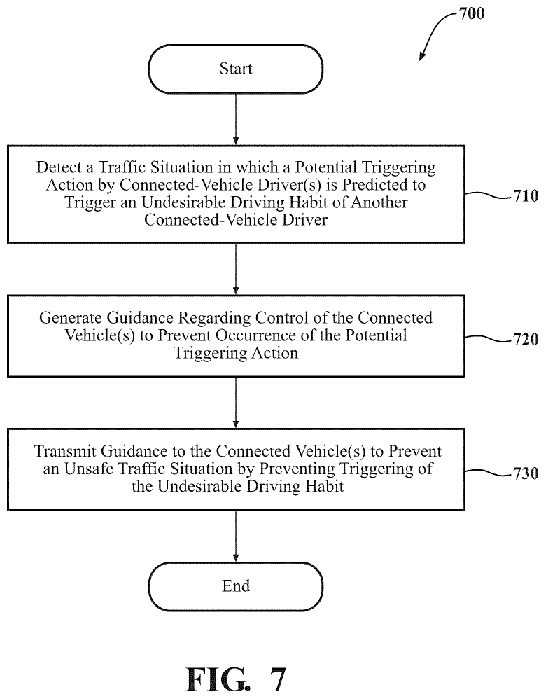

FIG. 7 is a flowchart of a method 700 of preventing unsafe driving behavior, in accordance with an illustrative embodiment of the invention. Method 700 will be discussed from the perspective of the unsafe driving behavior prevention system 200 in FIG. 6. While method 700 is discussed in combination with system 200, it should be appreciated that method 700 is not limited to being implemented within system 200, but system 200 is instead one example of a system that may implement method 700.

At block 710, detection module 615 detects a traffic situation in which a potential triggering action by one or more connected-vehicle drivers is predicted to trigger an undesirable driving habit of another driver. As discussed above in connection with FIG. 2, system 200 is in communication with the connected vehicles 100 and also with traffic information systems, map-data providers, and infrastructure systems (e.g., RSUs, edge servers, and/or traffic signals). Data regarding a particular connected-vehicle driver's undesirable driving habits and the actions of other drivers that tend to trigger those undesirable driving habits (triggering actions) has also been uploaded to the system 200 beforehand from the driver habits management systems 180 of the respective connected vehicles 100. By communicating with the connected vehicles 100, system 200 can track the location, speed, and trajectory of each connected vehicle 100 in real time. Information from these various sources in combination enables system 200 to detect a traffic situation in which a potential triggering action by one or more connected-vehicle drivers is predicted to trigger an undesirable driving habit of another driver. As discussed above, such a traffic situation is herein sometimes referred to as a “potentially triggering traffic situation. ” One example of a potentially triggering traffic situation and how system 200 might handle it is discussed above in connection with FIGS. 3A and 3B.

At block 720, guidance generation module 620 generates guidance 640 for the one or more connected-vehicle drivers regarding control of their respective connected vehicles to prevent the one or more connected-vehicle drivers from carrying out the potential triggering action. As discussed above, examples of guidance include, without limitation, a speed advisory, a lane-change instruction, and an instruction to permit a subject connected vehicle 100a or subject legacy vehicle to proceed, at a merge (e.g., merge intersection 340 in FIGS. 3A and 3B), ahead of an ego connected vehicle 100. As also mentioned above, in some potentially triggering traffic situations, system 200 can transmit guidance to a plurality of connected vehicles 100 to prevent a potential triggering action. As also discussed above, system 200 can take mitigating or compensating actions in situations where a connected-vehicle driver is unlikely to carry out the guidance received from system 200 or in which two or more aggressive drivers are involved in a potentially triggering traffic situation.

At block 730, communication module 630 transmits the guidance 640 to the one or more connected-vehicle drivers to prevent an unsafe traffic situation by preventing triggering of the undesirable driving habit of the subject driver.

FIG. 1 will now be discussed in full detail as an example connected vehicle 100 in accordance with various embodiments of the systems and methods for preventing unsafe driving behavior disclosed herein. In some instances, the connected vehicle 100 can be configured to switch selectively between an autonomous mode, one or more semi-autonomous operational modes, and/or a manual mode. Such switching, also referred to as handover when transitioning to a manual mode, can be implemented in a suitable manner, now known or later developed. “Manual mode” means that all of or a majority of the navigation and/or maneuvering of the vehicle is performed according to inputs received from a user (e.g., human driver/operator).

In one or more implementations, the connected vehicle 100 can be an autonomous vehicle. As used herein, “autonomous vehicle” refers to a vehicle that operates in an autonomous mode. “Autonomous mode” refers to navigating and/or maneuvering a vehicle along a travel route using one or more computing devices to control the vehicle with minimal or no input from a human driver/operator. In one implementation, the connected vehicle 100 is configured with one or more semi-autonomous operational modes in which one or more computing devices perform a portion of the navigation and/or maneuvering of the vehicle along a travel route, and a vehicle operator (i.e., driver) provides inputs to the vehicle to perform a portion of the navigation and/or maneuvering of the connected vehicle 100 along a travel route. Thus, in one or more implementations, the connected vehicle 100 operates autonomously according to a particular defined level of autonomy.

The connected vehicle 100 can include one or more processors 110. In one or more arrangements, the one or more processors 110 can be a main processor of the connected vehicle 100. For instance, the one or more processors 110 can be an electronic control unit (ECU). The connected vehicle 100 can include one or more data stores 115 for storing one or more types of data. The data store(s) 115 can include volatile and/or non-volatile memory. Examples of suitable data stores 115 include RAM, flash memory, ROM, PROM (Programmable Read-Only Memory), EPROM, EEPROM (Electrically Erasable Programmable Read-Only Memory), registers, magnetic disks, optical disks, hard drives, or any other suitable storage medium, or any combination thereof. The data store(s) 115 can be a component(s) of the one or more processors 110, or the data store(s) 115 can be operatively connected to the one or more processors 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangement, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangement, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the connected vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can function independently from each other. Alternatively, two or more of the sensors can work in combination with each other. In such a case, the two or more sensors can form a sensor network. The sensor system 120 and/or the one or more sensors can be operatively connected to the one or more processors 110, the data store(s) 115, and/or another element of the connected vehicle 100 (including any of the elements shown in FIG. 1).

The sensor system 120 can include any suitable type of sensor. Various examples of different types of sensors will be described herein. However, it will be understood that the implementations are not limited to the particular sensors described. The sensor system 120 can include one or more vehicle sensors 121. The vehicle sensors 121 can detect, determine, and/or sense information about the connected vehicle 100 itself, including the operational status of various vehicle components and systems.

In one or more arrangements, the vehicle sensors 121 can be configured to detect, and/or sense position and/orientation changes of the connected vehicle 100, such as, for example, based on inertial acceleration. In one or more arrangements, the vehicle sensors 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensors 121 can be configured to detect, and/or sense one or more characteristics of the connected vehicle 100. In one or more arrangements, the vehicle sensors 121 can include a speedometer to determine a current speed of the connected vehicle 100.

Alternatively, or in addition, the sensor system 120 can include one or more environment sensors 122 configured to acquire, and/or sense driving environment data. “Driving environment data” includes any data or information about the external environment in which a vehicle is located or one or more portions thereof. For example, the one or more environment sensors 122 can be configured to detect, quantify, and/or sense obstacles in at least a portion of the external environment of the connected vehicle 100 and/or information/data about such obstacles. The one or more environment sensors 122 can be configured to detect, measure, quantify, and/or sense other things in at least a portion the external environment of the connected vehicle 100, such as, for example, nearby vehicles, lane markers, signs, traffic lights, traffic signs, lane lines, crosswalks, curbs proximate the connected vehicle 100, off-road objects, etc.

Various examples of sensors of the sensor system 120 are discussed above. The example sensors may be part of the one or more environment sensors 122 and/or the one or more vehicle sensors 121. Moreover, the sensor system 120 can include operator sensors that function to track or otherwise monitor aspects related to the driver/operator of the connected vehicle 100. However, it will be understood that the implementations are not limited to the particular sensors described. As an example, in one or more arrangements, the sensor system 120 can include one or more radar sensors 123, one or more LIDAR sensors 124, one or more sonar sensors 125, and/or one or more cameras 126.

The connected vehicle 100 can further include a communication system 130. The communication system 130 can include one or more components configured to facilitate communication between the connected vehicle 100 and one or more communication sources. Communication sources, as used herein, refers to people or devices with which the connected vehicle 100 can communicate with, such as external networks, computing devices, operator or occupants of the connected vehicle 100, or others. As part of the communication system 130, the connected vehicle 100 can include an input system 131. An “input system” includes any device, component, system, element or arrangement or groups thereof that enable information/data to be entered into a machine. In one or more examples, the input system 131 can receive an input from a vehicle occupant (e.g., a driver or a passenger). The connected vehicle 100 can include an output system 132. An “output system” includes any device, component, or arrangement or groups thereof that enable information/data to be presented to the one or more communication sources (e.g., a person, a vehicle passenger, etc.). The communication system 130 can further include specific elements which are part of or can interact with the input system 131 or the output system 132, such as one or more display device(s) 133, and one or more audio device(s) 134 (e.g., speakers and microphones).

The connected vehicle 100 can include one or more vehicle systems 140. Various examples of the one or more vehicle systems 140 are shown in FIG. 1. However, the connected vehicle 100 can include more, fewer, or different vehicle systems. It should be appreciated that although particular vehicle systems are separately defined, each or any of the systems or portions thereof may be otherwise combined or segregated via hardware and/or software within the connected vehicle 100. The connected vehicle 100 can include a propulsion system 141, a braking system 142, a steering system 143, throttle system 144, a transmission system 145, a signaling system 146, and/or a navigation system 147. Each of these systems can include one or more devices, components, and/or combinations thereof, now known or later developed.

The one or more processors 110 and/or the autonomous driving module(s) 160 can be operatively connected to communicate with the various vehicle systems 140 and/or individual components thereof. For example, returning to FIG. 1, the one or more processors 110 and/or the autonomous driving module(s) 160 can be in communication to send and/or receive information from the various vehicle systems 140 to control the movement, speed, maneuvering, heading, direction, etc. of the connected vehicle 100. The one or more processors 110 and/or the autonomous driving module(s) 160 may control some or all of these vehicle systems 140 and, thus, may be partially or fully autonomous.

The connected vehicle 100 can include one or more modules, at least some of which are described herein. The modules can be implemented as computer-readable program code that, when executed by a processor 110, implement one or more of the various processes described herein. The processor 110 can be a device, such as a CPU, which is capable of receiving and executing one or more threads of instructions for the purpose of performing a task. One or more of the modules can be a component of the one or more processors 110, or one or more of the modules can be executed on and/or distributed among other processing systems to which the one or more processors 110 is operatively connected. The modules can include instructions (e.g., program logic) executable by one or more processors 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

In some implementations, the connected vehicle 100 can include one or more autonomous driving modules 160. The autonomous driving module(s) 160 can be configured to receive data from the sensor system 120 and/or any other type of system capable of capturing information relating to the connected vehicle 100 and/or the external environment of the connected vehicle 100. In one or more arrangements, the autonomous driving module(s) 160 can use such data to generate one or more driving scene models. The autonomous driving module(s) 160 can determine the position and velocity of the connected vehicle 100. The autonomous driving module(s) 160 can determine the location of obstacles, or other environmental features including traffic signs, trees, shrubs, neighboring vehicles, pedestrians, etc.

The autonomous driving module(s) 160 can be configured to determine travel path(s), current autonomous driving maneuvers for the connected vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the connected vehicle 100, changing travel lanes, merging into a travel lane, and/or reversing, just to name a few possibilities. The autonomous driving module(s) 160 can be configured can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the connected vehicle 100 or one or more systems thereof (e.g., one or more of vehicle systems 140). The noted functions and methods will become more apparent with a further discussion of the figures.

Detailed implementations are disclosed herein. However, it is to be understood that the disclosed implementations are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various implementations are shown in FIGS. 1-7, but the implementations are not limited to the illustrated structure or application.

The flowcharts and block diagrams in the figures illustrate the architecture, functionality, and operation of possible implementations of systems, methods, and computer program products according to various implementations. In this regard, each block in the flowcharts or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can be executed substantially concurrently, or the blocks can sometimes be executed in the reverse order, depending upon the functionality involved.

The systems, components and/or methods described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or methods also can be embedded in a computer-readable storage, such as a computer program product or other data programs storage device, readable by a machine, tangibly embodying a program of instructions executable by the machine to perform methods and methods described herein. These elements also can be embedded in an application product which comprises all the features enabling the implementation of the methods described herein and, which when loaded in a processing system, is able to carry out these methods.

Furthermore, arrangements described herein can take the form of a computer program product embodied in one or more computer-readable media having computer-readable program code embodied or embedded, such as stored thereon. Any combination of one or more computer-readable media can be utilized. The computer-readable medium can be a computer-readable signal medium or a computer-readable storage medium. The phrase “computer-readable storage medium” means a non-transitory storage medium. A computer-readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a RAM, a ROM, an EPROM or Flash memory, an optical fiber, a portable compact disc read-only memory (CD-ROM), a digital versatile disc (DVD), an optical storage device, a magnetic storage device, or any suitable combination of the foregoing. In the context of this document, a computer-readable storage medium can be any tangible medium that can contain, or store a program for use by, or in connection with, an instruction execution system, apparatus, or device.

Program code embodied on a computer-readable medium can be transmitted using any appropriate medium, including but not limited to wireless, wireline, optical fiber, cable, RF, etc., or any suitable combination of the foregoing. Computer program code for carrying out operations for aspects of the present arrangements can be written in any combination of one or more programming languages, including an object-oriented programming language such as Java™, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a LAN or a WAN, or the connection can be made to an external computer (for example, through the Internet using an Internet Service Provider).

In the description above, certain specific details are outlined in order to provide a thorough understanding of various implementations. However, one skilled in the art will understand that the invention may be practiced without these details. In other instances, well-known structures have not been shown or described in detail to avoid unnecessarily obscuring descriptions of the implementations. Unless the context requires otherwise, throughout the specification and claims which follow, the word “comprise” and variations thereof, such as, “comprises” and “comprising” are to be construed in an open, inclusive sense, that is, as “including, but not limited to. ” Further, headings provided herein are for convenience only and do not interpret the scope or meaning of the claimed invention.

Reference throughout this specification to “one or more implementations” or “an implementation” means that a particular feature, structure or characteristic described in connection with the implementation is included in at least one or more implementations. Thus, the appearances of the phrases “in one or more implementations” or “in an implementation” in various places throughout this specification are not necessarily all referring to the same implementation. Furthermore, the particular features, structures, or characteristics may be combined in any suitable manner in one or more implementations. Also, as used in this specification and the appended claims, the singular forms “a,” “an,” and “the” include plural referents unless the content clearly dictates otherwise. It should also be noted that the term “or” is generally employed in its sense including “and/or”unless the content clearly dictates otherwise.

The headings (such as “Background” and “Summary”) and sub-headings used herein are intended only for general organization of topics within the present disclosure and are not intended to limit the disclosure of the technology or any aspect thereof. The recitation of multiple implementations having stated features is not intended to exclude other implementations having additional features, or other implementations incorporating different combinations of the stated features. As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an implementation can or may comprise certain elements or features does not exclude other implementations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an implementation or particular system is included in at least one or more implementations or aspect. The appearances of the phrase “in one aspect” (or variations thereof) are not necessarily referring to the same aspect or implementation. It should also be understood that the various method steps discussed herein do not have to be carried out in the same order as depicted, and not each method step is required in each aspect or implementation.

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions. The term “module,” as used herein, is not intended, under any circumstances, to invoke interpretation of the appended claims under 35 U.S. C. § 112(f).

The terms “a” and “an,” as used herein, are defined as one as or more than one. The term “plurality,” as used herein, is defined as two or more than two. The term “another,” as used herein, is defined as at least a second or more. The terms “including” and/or “having,” as used herein, are defined as including (i.e., open language). The phrase “at least one of . . . and . . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC).

The preceding description of the implementations has been provided for purposes of illustration and description. It is not intended to be exhaustive or to limit the disclosure. Individual elements or features of a particular implementation are generally not limited to that particular implementation, but, where applicable, are interchangeable and can be used in a selected implementation, even if not specifically shown or described. The same may also be varied in many ways. Such variations should not be regarded as a departure from the disclosure, and all such modifications are intended to be included within the scope of the disclosure.

While the preceding is directed to implementations of the disclosed devices, systems, and methods, other and further implementations of the disclosed devices, systems, and methods can be devised without departing from the basic scope thereof. The scope thereof is determined by the claims that follow.

What is claimed is:

1. A system, comprising:
a processor; and
a memory storing machine-readable instructions that, when executed by the processor, cause the processor to:
detect a traffic situation in which a potential triggering action by one or more connected-vehicle drivers is predicted to trigger an undesirable driving habit of another driver;
generate guidance for the one or more connected-vehicle drivers regarding control of their respective connected vehicles to prevent the one or more connected-vehicle drivers from carrying out the potential triggering action; and
transmit the guidance to the one or more connected-vehicle drivers to prevent an unsafe traffic situation by preventing triggering of the undesirable driving habit.

2. The system of claim 1, wherein the undesirable driving habit of the another driver is learned by a machine-learning-based system in a connected vehicle driven by the another driver through automated observation of the driving of the another driver over a period of time preceding the detected traffic situation.

3. The system of claim 1, wherein the undesirable driving habit of the another driver is predicted through present analysis of driving behavior of the another driver by a machine-perception-based system in at least one connected vehicle driven by the one or more connected-vehicle drivers.

4. The system of claim 1, wherein an association between the potential triggering action and the undesirable driving habit is learned by a machine-learning-based system in a connected vehicle driven by the another driver through one or more of time-series analysis, retrospective analysis, and event clustering.

5. The system of claim 1, wherein the guidance includes one or more of a speed advisory, a lane-change instruction, and an instruction to permit a vehicle driven by the another driver to proceed, at a merge, ahead of a connected vehicle driven by one of the one or more connected-vehicle drivers.

6. The system of claim 1, wherein the another driver is human and at least one of the one or more connected-vehicle drivers is an automated driving system.

7. The system of claim 6, wherein the automated driving system carries out the guidance unconditionally.

8. The system of claim 1, wherein the system is implemented in a server that communicates with one or more connected vehicles driven by the respective one or more connected-vehicle drivers and with a connected vehicle driven by the another driver.

9. The system of claim 1, wherein the system is implemented in a distributed-computing fashion among a plurality of connected vehicles that are networked in a vehicular micro cloud.

10. A non-transitory computer-readable medium storing instructions that, when executed by a processor, cause the processor to:
detect a traffic situation in which a potential triggering action by one or more connected-vehicle drivers is predicted to trigger an undesirable driving habit of another driver;
generate guidance for the one or more connected-vehicle drivers regarding control of their respective connected vehicles to prevent the one or more connected-vehicle drivers from carrying out the potential triggering action; and
transmit the guidance to the one or more connected-vehicle drivers to prevent an unsafe traffic situation by preventing triggering of the undesirable driving habit.

11. The non-transitory computer-readable medium of claim 10, wherein the undesirable driving habit of the another driver is learned by a machine-learning-based system in a connected vehicle driven by the another driver through automated observation of the driving of the another driver over a period of time preceding the detected traffic situation.

12. The non-transitory computer-readable medium of claim 10, wherein the undesirable driving habit of the another driver is predicted through present analysis of driving behavior of the another driver by a machine-perception-based system in at least one connected vehicle driven by the one or more connected-vehicle drivers.

13. The non-transitory computer-readable medium of claim 10, wherein an association between the potential triggering action and the undesirable driving habit is learned by a machine-learning-based system in a connected vehicle driven by the another driver through one or more of time-series analysis, retrospective analysis, and event clustering.

14. A method, comprising:
detecting a traffic situation in which a potential triggering action by one or more connected-vehicle drivers is predicted to trigger an undesirable driving habit of another driver;
generating guidance for the one or more connected-vehicle drivers regarding control of their respective connected vehicles to prevent the one or more connected-vehicle drivers from carrying out the potential triggering action; and
transmitting the guidance to the one or more connected-vehicle drivers to prevent an unsafe traffic situation by preventing triggering of the undesirable driving habit.

15. The method of claim 14, wherein the undesirable driving habit of the another driver is learned by a machine-learning-based system in a connected vehicle driven by the another driver through automated observation of the driving of the another driver over a period of time preceding the detected traffic situation.

16. The method of claim 14, wherein the undesirable driving habit of the another driver is predicted through present analysis of driving behavior of the another driver by a machine-perception-based system in at least one connected vehicle driven by the one or more connected-vehicle drivers.

17. The method of claim 14, wherein an association between the potential triggering action and the undesirable driving habit is learned by a machine-learning-based system in a connected vehicle driven by the another driver through one or more of time-series analysis, retrospective analysis, and event clustering.

18. The method of claim 14, wherein the guidance includes one or more of a speed advisory, a lane-change instruction, and an instruction to permit a vehicle driven by the another driver to proceed, at a merge, ahead of a connected vehicle driven by one of the one or more connected-vehicle drivers.

19. The method of claim 14, wherein the another driver is human and at least one of the one or more connected-vehicle drivers is an automated driving system.

20. The method of claim 19, wherein the automated driving system carries out the guidance unconditionally.
